(19) United States
(12) Patent Application Publication
(10) Pub. No.: US 2013/0262172 A1
(43) Pub. Date: Oct. 3, 2013

(54) METHOD AND SYSTEM FOR THE OPERATION OF PLANTS

(71) Applicant: Sven Blümler, Tuchenbach (DE)

(72) Inventor: Sven Blümler, Tuchenbach (DE)

(21) Appl. No.: 13/991,660

(22) PCT Filed: Nov. 22, 2011
(86) PCT No.: PCT/US11/61775

§ 371 Date: Jun. 5, 2013

Related U.S. Application Data
(60) Provisional application No. 61/420,492, filed on Dec. 7, 2010.

(30) Foreign Application Priority Data
Dec. 7, 2010 (DE) 102010062494.2

(51) Int. Cl. G06Q 10/06

(52) U.S. Cl. CPC G06Q 10/06312
USPC 705/7.22

(57) ABSTRACT

A method for operation of plants includes a) Registering those operating resources which are present in a plurality of plants and have an influence on the functional capability of said plants, b) Specifying in each case first and second availability criteria for these operating resources, c) Registering availability data relating to the operating resources, d) comparing the availability data with the availability criteria, in order to determine operating resources which do not satisfy the availability criteria, e) For those operating resources that do not satisfy the first availability criterion: identifying measures by means of which the functional capability of the plants is extended by increasing the availability of the operating resource or by providing an alternate operating resource, and implementing these measures, f) For those operating resources that do not satisfy the second availability criterion: requesting and registering current availability data and repeating d.

### CROSS REFERENCE TO RELATED APPLICATIONS

This application is the US National Stage of International Application No. PCT/US2011/061775, filed Nov. 22, 2011 and claims the benefit thereof. The International Application claims the priority to application No. 61/420,492 filed Dec. 7, 2010 and to German application No. 102010062494.2 filed Dec. 7, 2010. All of applications are incorporated by reference herein in their entirety.

### FIELD OF INVENTION

The invention relates to a method and a system for the operation of plants.

### BACKGROUND OF INVENTION

The widest variety of operating resources are required for the operation of a plant, e.g. components, assemblies or devices of the plant, software that runs thereon (e.g. control software, regulating software, monitoring software or diagnostic software), or operating materials and auxiliary materials consumed during the operation of the plant.

During plant operation the problem arises that operating resources which are required for the operation of the plant are no longer manufactured after a certain time and therefore a replacement is no longer available in the event of a fault or operational wear affecting these operating resources. As a result, the functional capability and hence the service life of the plant is limited. In order to avoid this, partially faulty or worn operating resources are not replaced, or are replaced by other operating resources that are less suitable for the plant, though this can have an adverse effect on operational reliability, availability, performance and operational quality.

This problem arises primarily in the case of plants having a long service life, relatively modest unit volumes and stringent technical requirements in relation to the operating resources.

Examples of such plants include industrial plants (e.g. rolling mills, paper factories, refineries), installations for energy generation and distribution (e.g. power stations), infrastructure installations (e.g. airports, seaports, railway stations, communication installations), installations for the supply, removal or treatment of water (e.g. public drinking water supply, purification plants), health-related installations (e.g. hospitals), floating or underwater installations (e.g. ships, submarines, sea platforms), or rail vehicles.

The problem is exacerbated by the growing use of commercially available products (commercial off the shelf—COTS) having ever shorter lifecycles in such plants.

The underlying problem of “obsolescence”, i.e. the permanent transition from functional capability to non-functional due to a change from deliverability to non-deliverability of operating resources, has already been recognized and general recommendations for countering the problem have been published, e.g. in DIN-EN 62402 “Anleitung zum Obsoleszenzmanagement” (Guide to obsolescence management). Reactive and proactive measures are recommended in this case. The reactive measures include the search for residual stocks, cannibalization (breaking for spares), the repair (where possible) of operating resources that are no longer deliverable, the search for existing preferably equivalent alternate operating resources, and the development of preferably equivalent alternate operating resources. Recommended proactive measures include the implementation of obsolescence monitoring, i.e. the tracking of all operating resources and the application of measures to provide alternates when obsolescence is imminent or occurs in relation to any of the operating resources. Possible measures in this case include system upgrades or creating a final reserve stock of all affected operating resources or parts thereof.

However, these recommendations are often only partially suitable in the case of plants having a long service life, since very little participatory obligation can be expected from the manufacturers due to the relatively low unit volumes and, due to very stringent requirements in relation to the operating resources, high re-certification costs are also likely in the case of almost any change to operating resources or components thereof. Moreover, said recommendations can only be implemented at considerable expense in the case of plants comprising a multiplicity of operating resources. On the other hand, the suppliers of plants having a long service life are under strict contractual obligation to guarantee the availability over long periods of operating resources as replacements for faulty operating resources.

### SUMMARY OF INVENTION

Taking this as its starting point, the object of the present invention is to specify a method and a system for the operation of plants, said method and system allowing a long-term functional capability and/or service life of the plants without any reduction in their operational reliability, availability, performance or operational quality, at relatively low cost.

The inventive method for the operation of plants comprises:

a) Registering those operating resources which are present in a plurality of plants and have an influence on the functional capability of said plants,

b) Defining in each case first and second availability criteria for these operating resources,

c) Registering availability data relating to the operating resources,

d) Comparing the availability data relating to the operating resources with the availability criteria, in order to determine operating resources which do not satisfy the availability criteria,

e) For those operating resources that do not satisfy the first availability criterion: identifying measures by means of which the functional capability of the plants is extended by increasing the availability of the operating resource or by providing an alternate operating resource, and implementing these measures,

f) For those operating resources that do not satisfy the second availability criterion: requesting and registering current availability data and repeating the step d).

In addition to the plant components, assemblies, devices and software that runs thereon, and to the operating materials and auxiliary materials consumed during the operation of the plant, these having been mentioned previously in the introduction, the term “operating resources” in this case also comprises individual subassemblies and structural elements of the components, assemblies and devices.

In a first step a) those operating resources which limit the functional capability of the plants are therefore registered. According to the invention, this takes place over a plurality of (i.e. at least two) plants. The registration of the operating resources is preferably done on a computer system via a registration facility of the computer system, wherein the operating resources are stored in the form of operating resource data in a data storage of the computer system. The registration facility can allow e.g. manual registration by a user via an input facility, retrieval of data from a data storage (e.g. a data medium on which an operating resource index for the plants is stored), or a direct link to a second system (e.g. a planning system for the plants) for the purpose of data transfer to the computer system (e.g. via the Internet).

In a second step b), first and second availability criteria are specified in each case for each of these operating resources. This can be achieved particularly easily by predefining categories of operating resources, wherein said categories are in each case assigned a first and a second availability criterion, these being stored in the data storage of the computer system. As a result of assigning each of the registered operating resources to exactly one of these categories, the operating resource is automatically assigned the operating resources that are assigned to this category. The assignment can be effected e.g. by a user of the computer system by means of the input facility. Further availability criteria can also be specified in this case. The categories preferably differ according to the influence of the non-availability (and/or obsolescence) of an operating resource on the availability (obsolescence) of hierarchically higher modules or on schedules, the resulting side effects, the associated costs of said non-availability, and the extent to which alternate manufacturers can be used.

In a next step c), availability data relating to the operating resources is registered. In this context, availability data is understood to be data that gives an indication of the availability of an operating resource. In this case, the availability data can comprise delivery availability data and/or reserve stock availability data. The delivery availability data can be e.g. the date of the end of deliverability of the operating resource by a manufacturer, and reserve stock availability data can be e.g. information relating to a reserve stock level, the ownership structure of the reserve stock of operating resources and the date of this information.

The availability data can also be stored in a data storage of the computer system, for example, and can be registered in the computer system for this purpose by means of the registration facility of the computer system. The registration facility can allow e.g. manual registration of the availability data by a user via an input facility, or a direct link to systems of the manufacturer or distributor of the operating resources, or to procurement and/or stockkeeping systems of the plant operator and plant suppliers for the purpose of data transfer to the computer system (e.g. via the Internet). In this case, the provision of the availability data can take place on the basis of previous queries to the relevant data supplier (e.g. the plant operator, plant suppliers, manufacturers or distributors of the operating resources), or autonomously by the data supplier without previous queries. The queries and/or data deliveries preferably take place at regular time intervals in this case. Queries are preferably made via email or via Internet portals.

In a step d), the availability data relating to the operating resources is compared with the first and second availability criteria that are assigned in each case, in order to determine operating resources which do not satisfy the availability criteria. This comparison can be done e.g. by a microprocessor of the computer system, wherein said microprocessor accesses the availability data and availability criteria that are stored in the data storage. The availability criteria in this case preferably comprise a difference between deliverability data and reference data, in particular a calendar date, and/or between a reserve stock quantity and a reference quantity, in particular a required minimum quantity.

The first availability criterion is preferably a criterion for a particularly high criticality of a lack of availability (and/or obsolescence), and the second availability criterion is preferably a criterion for a medium criticality of a lack of availability (and/or obsolescence).

For those operating resources that do not satisfy the first availability criterion, provision is made in the step e) for identifying measures by means of which the functional capability of the plants is extended by increasing the availability of the operating resource or by providing an alternate operating resource. These measures are then implemented. If the operating resources have been assigned to categories (as described above), the identification of the measures is particularly simple because such measures have already been assigned to the categories.

In this case, the measures for these operating resources preferably comprise at least one or more measures from the following group:

e1) Generating a reserve stock of operating resources that are identical to these operating resources and replacing operating resources in the plant with operating resources from this reserve stock when the operating resources reach the end of their functional capability (so-called “creation of reserve stock for replacements”),

e2) Providing alternate operating resources (i.e. of a different type) to these operating resources and replacing operating resources in the plants with these alternate operating resources when the operating resources in the plants reach the end of their functional capability, wherein the plants are adapted to the alternate operating resources if necessary (so-called “system upgrade”),

e3) Replacing operating resources in at least some plants with identical operating resources from other plants (so-called “cannibalization”) when the operating resources in the at least some plants reach the end of their functional capability.

In this case, the identification of the measures is preferably done depending on reliability data and/or error data relating to the operating resources. This data is likewise preferably registered in the computer system via the registration facility of the computer system and stored in a data storage of the computer system. The registration facility can allow e.g. manual registration of the data by a user via an input facility, retrieval of data from a data storage (e.g. a data medium on which the reliability data and/or error data is stored), or a direct link to the plants (e.g. automation devices of the plants) for the purpose of registering the reliability data or to a plant-diagnosis or plant-error-analysis system of an operator or supplier of the plants for the purpose of registering the reliability data by means of data transfer to the computer system (e.g. via the Internet). Furthermore, the identification of the measures can be done depending on stock levels of the operating resource. The stock levels can already be part of the availability data.

For those operating resources that do not satisfy the second availability criterion, provision is made in the step f) for requesting and registering current availability data and for repeating the step d). The request for the availability data can be made to the data supplier (e.g. the plant operator, plant suppliers, manufacturer or distributor of the operating resources) automatically by the computer system via email or via Internet portals, for example.

For those operating resources that satisfy both the first and the second availability criteria, the step d) is repeated (preferably at regular time intervals). In this case, the wait time can vary depending on the category of the operating resources.

The invention therefore allows structured monitoring of the availability of the operating resources over two or more escalation levels in order to implement timely reactive or proactive measures for ensuring a long-term functional capability and service life of the plants.

The availability criteria allow the differing complexity of the operating resources and the effects of non-availability to be taken into consideration, in particular even if a search for alternate products is involved. It is also possible to provide information relating to availability periods that are still assured.

The inventive method allows a plurality of plants to be monitored concurrently for obsolescence in this case, i.e. a multi-plant approach is adopted. This has the advantage that the unit volumes of the operating resources that are monitored by the method are increased, and their significance vis-a-vis their manufacturers or distributors is clarified as a result of this pooling. This can have the effect of increasing the availability of the operating resources or simplifying the provision of alternate operating resources. Moreover, this pooling can result in a reduction of the overall cost of implementing the method for the individual plants. For example, availability requests to plant operators, plant suppliers, manufacturers or distributors of the operating resources can therefore be initiated in an effective and pooled manner, instead of being initiated separately for each plant, wherein the replies can likewise be registered in an effective and pooled manner, and measures introduced if the availability criteria are not satisfied.

It is also possible automatically to generate reports relating to the operating resources that satisfy or do not satisfy the availability criteria.

The method can also be linked to a virtual organization containing roles in respect of various rights and obligations relating to the implementation of the individual method steps and to the monitoring of this implementation. The individual users can then be assigned to these roles. For example, the reports can be forwarded directly to the appropriate user as defined by the framework of roles.

As a result of these clear assignments of rights and obligations, the effectiveness and the reliability of implementation are further increased in the management of obsolescence.

As a result this allows a long-term functional capability and/or service life of a plant without any reduction in its operational reliability, availability, performance or operational quality, at relatively low cost.

In order to achieve a particularly economical approach, at least the registration of the operating resources in the step a), the specification of the availability criteria in the step b), the registration of the availability data in the step c), and the comparison of the availability data with the availability criteria in the step d) are performed with the support of a computer program.

The method explained above can be realized at least in parts by means of a system, in particular a computer system.

This system firstly comprises a registration facility (e.g. a keyboard or a serial, parallel, USB, Ethernet or other interface) for registering data relating to those operating resources which is present in a plurality of plants and has an influence on the functional capability of the plants, and for registering availability data relating to the operating resources. The system further comprises a comparison facility for comparing the availability data relating to the operating resources with a first and a second availability criterion in each case, in order to determine operating resources which do not satisfy these availability criteria. The system further comprises an identification facility for identifying measures for those operating resources which do not satisfy the first availability criterion, wherein by virtue of the measures the functional capability of the plants is extended by increasing the availability of the operating resource or by providing an alternate operating resource. Both the comparison facility and the identification facility can take the form of a microprocessor which accesses data in working memory or in hard disk storage, for example. The system further comprises an output facility, e.g. a screen or a printer, for outputting those operating resources (as determined by the comparison facility) which do not satisfy the first availability criterion, and for outputting the measures that are identified by the identification facility.

In this case, the registration facility is preferably designed to register data relating to the operating resources from an electronic operating resource index of an operator or supplier of the plants and/or to register data relating to the operating resources from a planning system of a supplier of the plants. The data relating to the operating resources can be registered very economically in this way.

Very economical registration of the availability data is possible by virtue of the registration facility being designed to register availability data from manufacturers or distributors of the operating resources and/or to register availability data from a procurement and stockkeeping system of an operator or supplier of the plants.

The registration facility can also be designed to register reliability data relating to the operating resources from the plants and/or to register error data relating to the operating resources from a plant-diagnosis or plant-error-analysis system of an operator or supplier of the plants. This allows very prompt and economical registration of this data for accurate monitoring of the availabilities.

The invention also relates to a data storage and a computer program that is stored therein, wherein said computer program executes the following steps when it is executed on a computer:

a) Requesting and registering those operating resources which have an influence on the functional capability of plants,

b) Requesting and registering availability data relating to the operating resources,

c) Comparing the availability data relating to the operating resources with a first and a second availability criterion, in order to determine operating resources which do not satisfy the availability criteria,

d) For those plant parts that do not satisfy the first availability criterion:

Identifying measures by means of which the functional capability of the plants is extended by increasing the availability of the operating resource or by providing an alternate operating resource,

Outputting the operating resources and the measures that are identified in each case.

The data storage can be a CD or a DVD, a hard disk or a server database, for example.

The use of the invention is not in any way restricted to the plants cited in the introduction, but can equally be used for monitoring obsolescence in respect of technical devices that are marketed as individual products (e.g. engines, turbines, transformers, rectifiers, switches, control devices, medical devices, water purification devices, fuel cells, communication devices), their assemblies and structural elements, and software that runs thereon.

### BRIEF DESCRIPTION OF THE DRAWINGS

The invention and advantageous embodiments of the invention in accordance with features in the subclaims are explained in greater detail below with reference to exemplary embodiments in the figures, in which:

FIG. 1 shows an advantageous integration of a system according to the invention into a system environment,

FIG. 2 shows a method sequence according to the invention in the form of a flow diagram,

FIG. 3 shows a system for implementing the invention,

FIG. 4 shows a flow diagram of method steps that can be performed before the method sequence illustrated in FIG. 2.

### DETAILED DESCRIPTION OF INVENTION

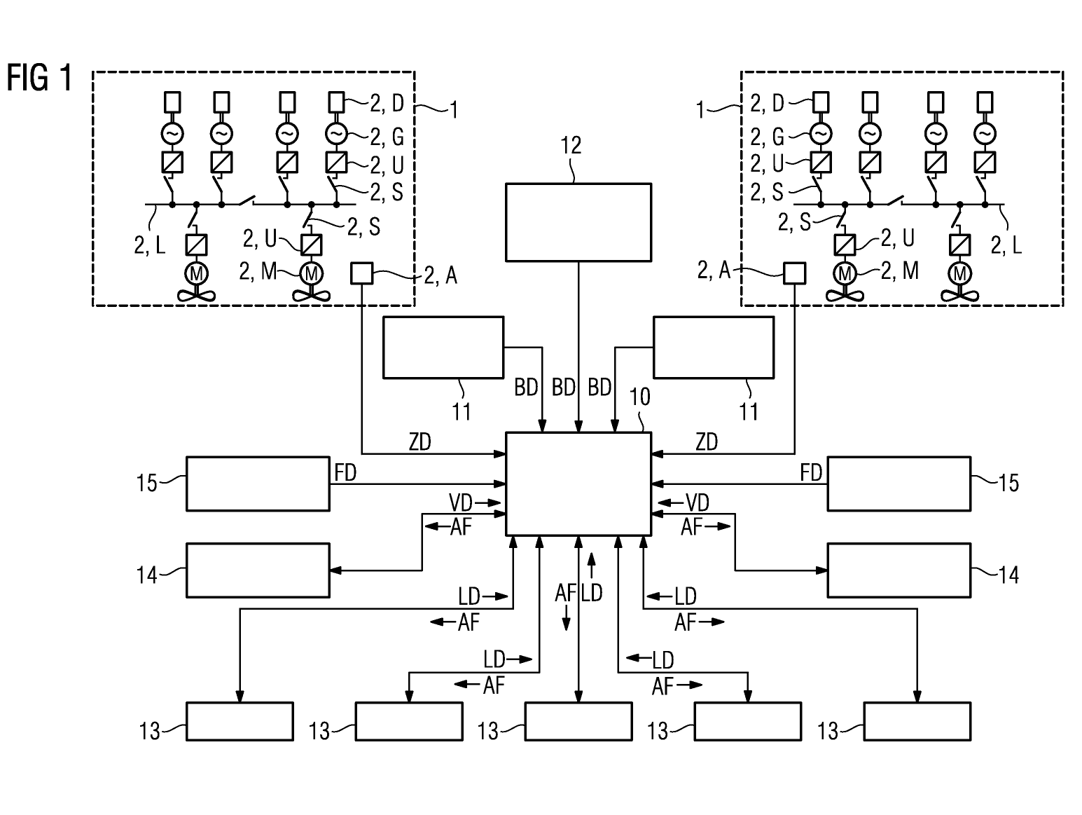

FIG. 1 shows two plants 1, which comprise a multiplicity of different electrical and mechanical operating resources 2 such as e.g. diesel engines D, generators G, voltage converters U, switches S, motors M, line connections L, and automation engineering components such as e.g. programmable logic controllers A. In the example illustrated here, the plants 1 are floating or underwater installations such as surface or underwater vessels. However, the plants 1 can also be e.g. industrial plants (e.g. rolling mills, paper factories, refineries), installations for energy generation and distribution, infrastructure installations (e.g. airports, seaports, railway stations), installations for the supply, removal or treatment of water (e.g. public drinking water supply, purification plants), health-related installations (e.g. hospitals) or rail vehicles.

More than two plants 1 might also be present in this case, wherein these might be identical or differ partially in respect of the type or number of their operating resources 2.

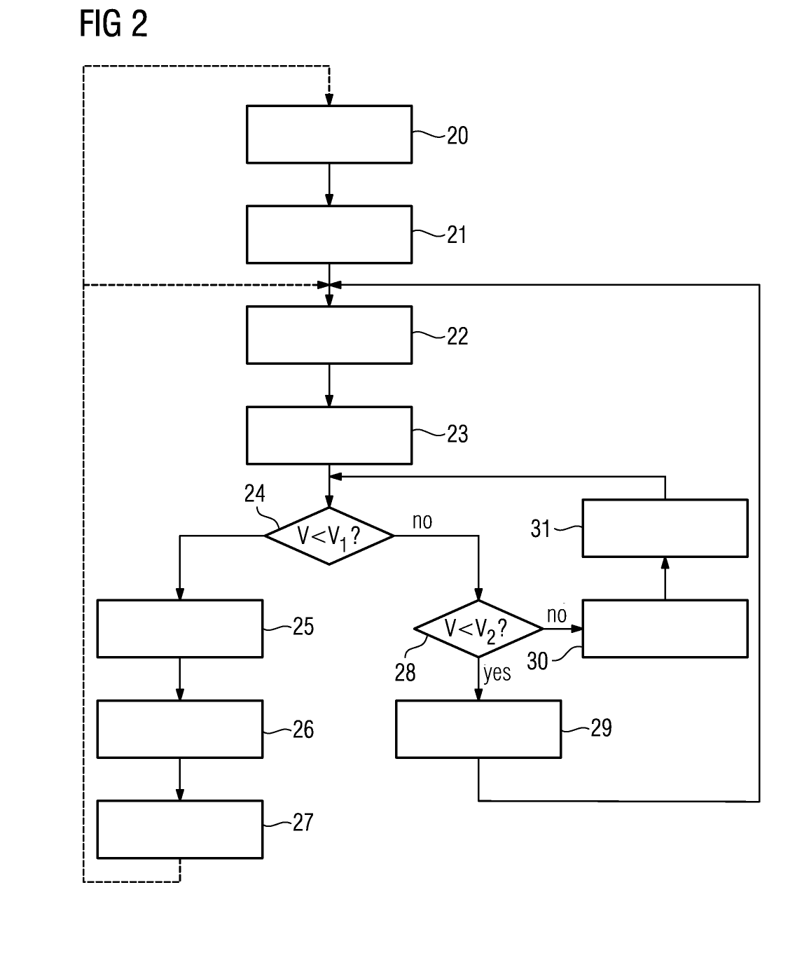

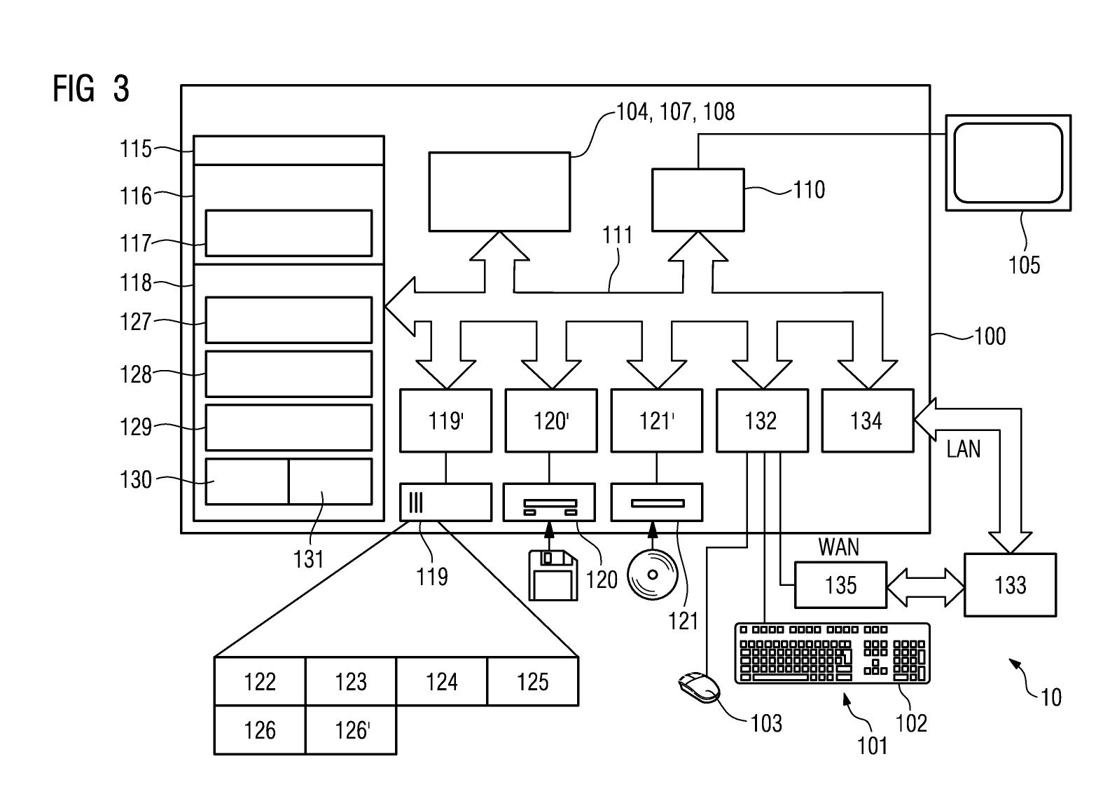

Viewed in conjunction with FIG. 1, FIG. 2 shows that those operating resources 2 which have an influence on the functional capability and/or service life of the plants 1 are registered on a computer system 10 in a first step 20 during operation of the plants 1. As illustrated in detail in FIG. 3, the computer system 10 comprises a computer 100 and a data registration facility 101 for this purpose, wherein said data registration facility 101 comprises inter alia an input facility in the form of a keyboard 102 and a computer mouse 103 for manual registration of data BD relating to the operating resources 2 by a user. In addition, the data registration facility 101 also comprises a DVD drive 121 by means of which data BD relating to the operating resources 2 can be retrieved from an electronic operating resource index 11, which relates to the plants and is stored on a DVD, and can be stored in data storage in the form of a hard disk 119 of the computer 100. Moreover, the registration facility 101 can also feature an interface for transferring the data BD relating to the operating resources 2 from a planning system 12 of the plants 1.

In a second step 21, the operating resources 2 are assigned to predefined categories of operating resources. These categories are assigned at least a first availability criterion V1 and a second availability criterion V2 in each case. As a result of the operating resources 2 being assigned to these categories, the availability criteria V1, V2 are automatically specified for these operating resources 2. The assignment of the operating resources 2 to the categories can be done e.g. by a user of the computer system 10 by means of the keyboard 102 and with the aid of the computer mouse 103.

The categories differ according to the influence of the non-availability (and/or obsolescence) of an operating resource 2 on the availability (obsolescence) of hierarchically higher modules or on schedules, the resulting side effects, the associated costs of said non-availability, and the extent to which alternate manufacturers can be used.

For example, provision is made for four categories, A, B, C, D, which differ by virtue of the following features:

Category A

Operating resources whose obsolescence would have an extremely serious influence on the obsolescence of one or more complete modules.

Operating resources whose obsolescence almost immediately affects schedules and other obligations.

Operating resources whose obsolescence is associated with further extreme side effects and maximum cost.

Operating resources in Category A are extremely specialized (e.g. in-house developments, custom installations) and therefore finding alternate manufacturers is almost impossible.

Category B

Operating resources whose obsolescence can have a serious influence on the obsolescence of a module.

Operating resources whose obsolescence has limited side effects but can be associated with extremely high costs.

Operating resources in Category B can be obtained from alternate manufacturers but their certification can be lengthy and cost intensive.

Category C

Operating resources whose obsolescence has a comparatively minor influence on the obsolescence of a module.

Operating resources whose obsolescence has very few side effects and is usually associated with comparatively low costs.

Operating resources in Category C can be obtained from alternate manufacturers (or alternate products from the same manufacturer) and their certification is considered to be largely problem-free.

Operating resources in Category C are inter alia COTS (commercial off the shelf) products requiring little or no adaptation.

Category D

This includes operating resources which for various reasons do not require the implementation of any anticipatory measures or monitoring.

Operating resources in Category D are trivial products which are not expected to represent a problem in the event of imminent obsolescence.

The first availability criterion V1 is preferably a criterion for a particularly high criticality of a lack of availability (and/or obsolescence), and the second availability criterion V2 is preferably a criterion for a medium to low criticality of a lack of availability (and/or obsolescence). The availability criteria V1, V2 will usually differ according to category in this case.

In a next step 22, availability data relating to the operating resources 2 is requested from e.g. manufacturers or distributors 13 of the operating resources 2, from plant operators or from plant suppliers by means of queries AF. In this context, availability data is understood to mean data that gives an indication of the availability of an operating resource. In this case, the availability data comprises delivery availability data LD and reserve stock availability data VD.

The delivery availability data LD comprises the date of the end of deliverability of the operating resource 2 by a manufacturer, and the reserve stock availability data VD comprises information relating to a reserve stock level, the ownership structure of the reserve stock of operating resources and the date of this information.

Alternatively, the provision of the availability data LD, VD can also be effected by the relevant data supplier (e.g. the plant operator, plant suppliers, manufacturer or distributor of the operating resources) without previous queries AF if said data supplier supplies the data autonomously, e.g. at regular time intervals.

In a step 23, the availability data LD, VD is registered in the computer system 10. For this purpose, the registration facility 101 can feature an interface via which the delivery availability data LD is transferred from manufacturers or distributors 14 of the operating resources 2 to the computer system 10 and is stored in the data storage 119. The reserve stock availability data VD can be transferred from procurement systems and/or stockkeeping systems 14 of the plant operator or plant suppliers to the computer system 10 and stored in the data storage 119 via the same interface or a different interface of the registration facility 101. Alternatively, the availability data LD, VD can also be input into the computer system 10 and stored in the data storage 119 manually by a user via the keyboard 102 and mouse 103.

In a step 24, the computer system 10 performs a comparison of the availability data LD, VD relating to the operating resources 2 with the respectively assigned first availability criterion V1, in order to determine operating resources 2 which do not satisfy the availability criterion V1. This comparison can be performed e.g. by a microprocessor 104 of the computer 100 (see FIG. 3), wherein said microprocessor 104 accesses the availability data LD, VD and availability criteria V1, V2 that are stored in the data storage 119. In this case, the availability criteria comprise a difference between deliverability data and reference data, in particular a calendar date, and a difference between a reserve stock quantity and a reference quantity, in particular a required minimum quantity.

For those operating resources 2 which do not satisfy the first availability criterion V1, an availability status indicating a high criticality is set in the computer system 10 in a step 25, i.e. indicating that without corresponding countermeasures these operating resources 2 are likely to limit the functional capability and/or service life of the plants 1. Furthermore, in a step 26, measures are identified by means of which the functional capability and/or service life of the plants 1 is extended by increasing the availability of the operating resource 2 or by procuring alternate operating resources. These measures are then implemented in a step 27.

In order to allow simple identification of the measures, one or more such measures are already assigned to the categories of the operating resources 2.

In this case, the measures for these operating resources 2 firstly comprise generating a reserve stock of operating resources that are identical to these operating resources 3 (so-called “creation of reserve stock for replacements”) and replacing operating resources 2 in the plants 1 with operating resources from this reserve stock when the operating resources 2 reach the end of their functional capability and/or service life and have to be exchanged. The measures secondly comprise providing alternate operating resources (i.e. of a different type) to these operating resources 2 and replacing operating resources in the plants 1 with these alternate operating resources when the operating resources 2 reach the end of their functional capability and/or service life and have to be exchanged (so-called “alternate operating resources”), wherein the plants 1 are adapted to the alternate operating resources if necessary (so-called “system upgrades”). The measures also comprise replacing operating resources 2 in the plants 1 with identical operating resources from one or more other plants (so-called “cannibalization”).

In this case, the identification of the measures is preferably done depending on reliability data ZD (i.e. data that provides information relating to the reliability of the operating resources, e.g. downtimes of the operating resources) and/or error data FD (i.e. data that provides information relating to the exact type and number of errors, the frequency of replacement, etc.) relating to the operating resources 2. For the purpose of registering the reliability data ZD, the data registration facility 101 has an interface via which the data is transferred directly from the plants 1 (e.g. from the automation devices A of the plants) into the computer system 10 and is stored in the data storage 119.

The error data FD can be transferred from plant-diagnosis or plant-error-analysis systems 15 of an operator or supplier of the plants 1 into the computer system and stored in the data storage 119 via the same interface or a different interface of the data registration facility 101. Alternatively, this data ZD, FD can also be input into the computer system 100 and stored therein in the data storage 119 manually by a user by means of the keyboard 102 and mouse 103.

The reliability data ZD and/or error data FD makes it possible for the future demand in respect of operating resources to be predicted and for this prediction to be taken into consideration during the identification of the measures.

In addition, the identification of the measures can also be done depending on stock levels of the operating resources, wherein the stock levels are also part of the reserve stock availability data VD.

Depending on the measure that is implemented, provision is then made for returning to one of the previous steps. If an alternate operating resource has been installed, it is necessary to return to the step 20 for the purpose of registering the alternate operating resource in the computer system 10, and to execute the subsequent method steps for the purpose of registering availability data relating to this alternate operating resource. If creation of reserve stock for replacements or cannibalization of an operating resource has taken place, the new availability data must be registered in the computer system 100 in accordance with step 23.

For those operating resources 2 which satisfy the first availability criterion V1, the availability data relating to the operating resources 2 is compared with the availability criterion V2 in a following step 28, in order to determine operating resources that do not satisfy the availability criterion V2.

This comparison is likewise performed e.g. by a microprocessor 104 of the computer 100 (see FIG. 3), wherein said microprocessor 104 accesses the availability data LD, VD and the availability criterion V2 that are stored in the data storage 119. In this case, the availability criterion V2 comprises a difference between deliverability data and reference data, in particular a calendar date, and a difference between a reserve stock quantity and a reference quantity, in particular a required minimum quantity.

The microprocessor 104 therefore has the function of a comparison facility 107 for comparing the availability data LD, VD relating to the operating resources 2 with a first and a second availability criterion V1 and V2 in each case, in order to determine operating resources 2 that do not satisfy these availability criteria V1, V2, and has the function of an identification facility 108 for identifying measures for those operating resources 2 which do not satisfy the first availability criterion V1, wherein by virtue of the measures the functional capability of the plant is extended by increasing the availability of the operating resource 2 or by providing an alternate operating resource.

For those operating resources 2 which do not satisfy the second availability criterion V2, an availability status indicating a medium criticality is set in the computer system 10 in a subsequent step 29, i.e. indicating that without corresponding countermeasures these operating resources 2 are likely to limit the functional capability and/or service life of the plants 1.

Provision is then made for returning to the step 22, i.e. actively requesting current availability data and then repeating the steps which follow the step 22.

For those operating resources 2 which satisfy all availability criteria V1, V2, an availability status indicating no criticality is set in the computer system 10 in a subsequent step 30. After expiry of a wait time in a step 31, said wait time being dependent on the category of the operating resource, provision is made for repeating the step 22 and the steps following this.

Using the availability status, it is easily possible for the computer system 10 to automatically generate reports which list e.g. all operating resources having a status of high criticality or all operating resources having a status of medium criticality. The relevant availability status can also be output on a screen 105 of the computer system 10 and symbolized by means of color coding (e.g. as per the traffic light system) for the availability status (e.g. red for a status of high criticality, yellow for a status of medium criticality, and green for no criticality).

Roles and rules, which rules define the rights and obligations associated with each role in the method sequence shown in FIG. 2, can be stored in the computer system 10 for the users of the computer system 10. Examples of this are as follows: right to define categories and to specify the respectively assigned availability criteria and measure, right to register operating resources, right to assign the operating resources to the categories, right/obligation to perform availability requests, right to register availability data, obligation to implement the measures, right to establish roles and to modify the rights and obligations of the roles, right to assign users to roles, recipients of selected automatically generated reports, etc.

FIG. 3 shows the computer system 10 as per FIG. 1 in greater detail, comprising the computer 100 whose output is sent to the screen 105 via a graphics card 110. The computer 100 comprises a central microprocessor 104, which is linked via a system bus 111 to a system memory 115. The system memory 115 comprises the ROM (read only memory) 116, the BIOS (basic input/output system) 117, and the working memory in the form of RAM (random access memory) 118. The computer 10 further comprises a hard disk 119, a floppy disk drive 120 and a DVD drive 121. The hard disk 119, the floppy disk drive 120 and the DVD drive 121 are linked via respective interfaces 119′, 120′ and 121′ to the system bus 111.

The hard disk 119 is used to store an operating system 122, a computer program 123, data 124 relating to the operating resource categories, the assigned availability criteria and the measures, data 125 relating to the registered operating resources 2, the availability data 126 and the error and reliability data 126′.

When the program 123 is called, it is loaded into the working memory 118, where its first program function 127 is to request and register those operating resources which are present in a plurality of plants and have an influence on the service life of said plants, its second program function 128 is to assign the operating resources 2 to categories, its third program function 129 is to request and register availability data, its fourth program function 130 is to compare the availability data relating to the operating resources with the availability criteria in order to determine those operating resources which do not satisfy the availability criteria, and its fifth program function 131 is to identify measures by means of which the functional capability of the plants 1 is extended by increasing the availability of the operating resource or by providing an alternate operating resource, and to output these measures e.g. to the screen 105, to a printer that is connected to the computer 100, or by creating a file in which these measures are described.

During the execution of the program 123, the system 10 requests operating resources 2 and availability data LD, VD. These can be typed in via the keyboard 102 by the user with the aid of a computer mouse 103, wherein the data arrives in the working memory 115 via the serial interface 132 and the system bus 111.

Alternatively, the data can be provided by one of the systems 12, 13, 14, 15 or electronic directories 11 shown in FIG. 1, more simply denoted here by the reference sign 133, and registered in the computer system 100. If the computer 100 is part of a LAN, the data can arrive at the system bus 111 via a network card 134. If the computer 100 is part of a WAN, the data is transferred to the system bus 111 via a modem or router 135 and via the serial interface 132. Of course, other interfaces such as e.g. USB, Bluetooth, WLAN can also be used for the data transfer and/or for reading the data in.

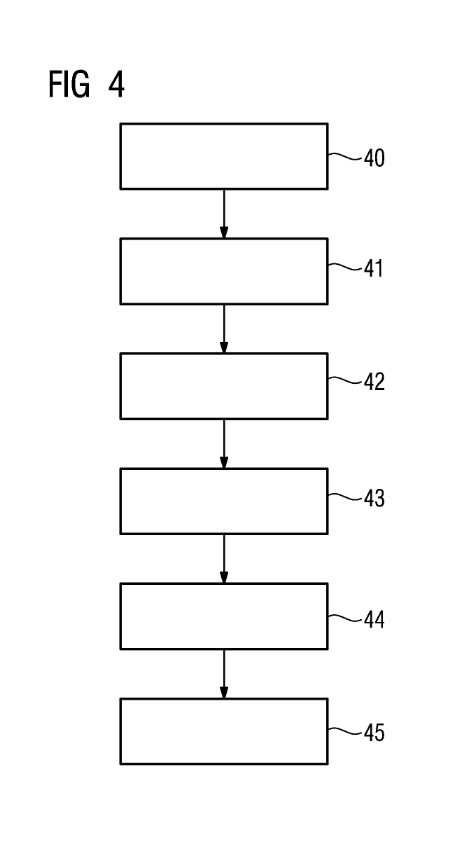

In a particularly advantageous embodiment, provision is made for additionally executing the method steps that are illustrated in FIG. 4 in the form of a flow diagram before the method sequence as illustrated in FIG. 2. In this case, the number of categories of the operating resources is initially registered in a step 40. The number is selected e.g. depending on the magnitude of the number of operating resources which have an influence on the functional capability of the plant. Once this magnitude has been specified, the user of the computer system 10 is already offered a number of categories. In a step 41, these categories are then individualized, i.e. the user can allocate (as preferred) a name or a number or a letter to the categories for the purpose of identification. In a step 42 following thereupon, provision is made for specifying the format in which the anticipated losses will be quantified in the event of non-availability of the operating resource (e.g. magnitude of losses in terms of EUR, losses in terms of work hours, losses in terms of plant downtimes, losses/delivery delays in terms of calendar periods). In a step 43 following thereupon, provision is made for assigning measures for increasing the availability to the categories defined in the step 31. For this purpose, a list of such measures is proposed to the user of the computer system 10 in each case. Finally, in a step 44, roles for the execution of the method steps illustrated in FIG. 2 are specified by a user on the basis of a proposal list that is generated by the computer system 10, and the rights and obligations for said roles are then specified by the user in a step 45.

1. A method for the operation of plants, comprising:
a) registering operating resources which are present in a plurality of plants and have an influence on the functional capability of said plants;
b) specifying in each case first and second availability criteria for the operating resources;
c) registering availability data relating to the operating resources;
d) comparing the availability data relating to the operating resources with the availability criteria, in order to determine operating resources which do not satisfy the availability criteria;
e) for those operating resources that do not satisfy the first availability criterion: identifying measures by means of which the functional capability of the plants is extended by increasing the availability of the operating resource or by providing an alternate operating resource, and implementing these measures; and
f) for those operating resources that do not satisfy the second availability criterion: requesting and registering current availability data and repeating the step d).

2. The method as claimed in claim 1,
wherein the measures in the step e) comprise at least one or more of the following measures:
generating a reserve stock of operating resources that are identical to these operating resources, and replacing operating resources in the plants with operating resources from this reserve stock when the operating resources in the plants reach the end of their functional capability,
providing alternate operating resources to these operating resources, and replacing operating resources in the plants with these alternate operating resources when the operating resources in the plants reach the end of their functional capability,
replacing operating resources in at least some plants with identical operating resources from other plants when the operating resources in the at least some plants reach the end of their functional capability.

3. The method as claimed in claim 1,
wherein the availability data comprises delivery availability data and/or reserve stock availability data.

4. The method as claimed in claim 1,
wherein the availability criteria comprise a difference between availability data and reference data, in particular a calendar date, and/or a difference between a reserve stock quantity and a reference quantity, in particular a minimum quantity.

5. The method as claimed in claim 1,
wherein the identification of the measures in the step e) is done depending on reliability data relating to the operating resources.

6. The method as claimed in claim 1,
wherein the identification of the measures in the step e) is done depending on error data relating to the operating resources.

7. The method as claimed in claim 1,
wherein the identification of the measures in the step e) is done depending on stock levels of the operating resource.

8. The method as claimed in claim 1,
wherein the operating resources are assigned in each case to a category of operating resources, wherein each category is assigned a first and a second availability criterion in each case.

9. The method as claimed in claim 1,
wherein roles comprising rights and obligations are defined for the execution of the steps a) to f), and wherein users of the method are assigned to at least one role in each case.

10. A system for the operation of plants, comprising:
a registration facility for registering data relating to those operating resources which are present in a plurality of plants and have an influence on the functional capability of the plants, and for registering availability data relating to the operating resources;
a comparison facility for comparing the availability data relating to the operating resources with a first and a second availability criterion in each case, in order to determine operating resources which do not satisfy these availability criteria;
an identification facility for identifying measures for those operating resources which do not satisfy the first availability criterion, wherein by virtue of the measures the functional capability of the plants is extended by increasing the availability of the operating resource or by providing an alternate operating resource; and
an output facility for outputting those operating resources, as determined by the comparison facility, which do not satisfy the first availability criterion, and for outputting the measures that are identified by the identification facility.

11. The system as claimed in claim 10,
wherein the measures that are identified by the identification facility comprise at least one or more of the following measures:
generating a reserve stock of operating resources that are identical to these operating resources, and replacing operating resources in the plants with operating resources from this reserve stock when the operating resources in the plants reach the end of their functional capability,
providing alternate operating resources to these operating resources, and replacing operating resources in the plants with these alternate operating resources when the operating resources in the plants reach the end of their functional capability,
replacing operating resources in at least some plants with identical operating resources from other plants when the operating resources in the at least some plants reach the end of their functional capability.

12. The system as claimed in claim 10,
wherein the registration facility is designed to register data relating to the operating resources from an electronic operating resource index of an operator or supplier of the plants.

13. The system as claimed in claim 10,
wherein the registration facility is designed to register data relating to the operating resources from a planning system of a supplier of the plants.

14. The system as claimed in claim 10,
wherein the registration facility is designed to capture availability data from manufacturers or distributors of the operating resources.

15. The system as claimed in claim 10,
wherein the registration facility is designed to capture availability data from a procurement and stockkeeping system of an operator or supplier of the plants.

16. The system as claimed in claim 10,
wherein the registration facility is designed to register reliability data relating to the operating resources from the plants.

17. The system as claimed in claim 10,
wherein the registration facility is designed to register error data relating to the operating resources from a plant-diagnostic or plant-error-analysis system of an operator or supplier of the plants.

18. A data storage and a computer program that is stored therein,
wherein said computer program executes the following steps when it is executed on a computer:
a) requesting and registering operating resources which have an influence on the functional capability of plants;
b) requesting and registering availability data relating to the registered operating resources;
c) comparing the availability data relating to the operating resources with a first and a second availability criterion, in order to determine operating resources which do not satisfy the availability criteria;
d) for those plant parts that do not satisfy the first availability criterion:
identifying measures by means of which the functional capability of the plants is extended by increasing the availability of the operating resource or by providing an alternate operating resource; and
outputting the operating resources and the measures that are identified in each case.
